(19) United States
(12) Patent Application Publication
(10) Pub. No.: US 2022/0125055 A1
(43) Pub. Date: Apr. 28, 2022

(54) Method of Controlling Citrus Greening Disease

(71) Applicant: UPL Limited, Mumbai (IN)

(72) Inventor: Carlos Eduardo Fabri, Ituverava (BR)

(21) Appl. No.: 17/436,182

(22) PCT Filed: Mar. 30, 2020
(86) PCT No.: PCT/IB2020/051786

§ 371 Date: Sep. 3, 2021

(30) Foreign Application Priority Data
Mar. 11, 2019 (IN) 201921009420

(51) Int. Cl. A01N 59/06; A01N 59/20; A01P 17/00; A01P 7/04; A01N 37/18

(52) U.S. Cl. CPC A01N 59/06; A01N 59/20; A01N 37/18; A01P 7/04; A01P 17/00

(57) ABSTRACT

The present disclosure relates to a method of controlling citrus greening disease in citrus crop, said method comprising contacting the affected citrus crop with calcium carbonate upto about 15 days from the emergence of the Diaphorina citri in the citrus crop.

### FIELD OF INVENTION

The present invention relates to the field of plant protection, particularly, to a method for the effective control of citrus greening disease.

### BACKGROUND OF THE INVENTION

Asian citrus psyllid (ACP), Diaphorina citri Kuwayama, Hemiptera: Psyllidae, is a phloem feeding insect native to Asia and the Far East with a host range of only Citrus spp. and its near rutaceae relatives. Diaphorina citri is the vector insect of the bacterium Candidatus Liberibacter spp., Psyllid are usually found in sprouts—they prefer sprouts to feed and reproduce, but they can also be observed on mature leaves, especially on the underside. Diaphorinacitri (D. citri) causes little direct feeding damage, but it vectors the phloem limited bacterial citrus pathogens, ‘Candidatus Liberibacter asiaticus’, ‘C. L. africanus’, and ‘C. L. americanus’, which cause ‘citrus greening disease’ or Huanglongbing (HLB), a disease which is considered one of the most damaging to citrus. The impact of this disease on world citrus production and concern over its continued spread have led to research on the vector's plant host range, interactions with parasitoids and host-vector-pathogen interactions.

Application of insecticides and antibiotics is the most widely followed option for reducing ACP populations in citrus-growing regions. However, these techniques are temporary and may not be useful to fully control the D. citri. There is a desired need to find a sustainable solution to control of D. citri populations and so prevent the citrus green disease.

The present invention is directed towards a disease control strategy to control the spread of the citrus green disease due to entrenched vector population by Diaphorina citri.

The present invention thus provides a method of controlling adults of Diaphorina citri thereby preventing citrus green disease or Huanglongbing (HLB) in the plants.

### OBJECT OF THE INVENTION

It is an object of the present invention to provide a method for controlling the Citrus psylla.

It is another object of the invention to provide a safe, quick and effective method for the prevention and control of Citrus psylla.

It is an object of the present invention to provide a method for controlling citrus psyllid, this method has the advantage of constantly reducing the attack of Citrus psylla in citrus plants.

In is another object of the present invention to provide a method of preventing an increase of adult Citrus psylla population.

It is an object of the present invention to provide a method which does not affect the normal growth of plants.

### SUMMARY OF THE INVENTION

In an aspect the present invention provides a method for controlling the Citrus psylla.

In another aspect the invention provides quick and effective method for controlling Citrus psylla and preventing the citrus green disease in citrus crops. In another aspect the present invention improves the control method, and solve the problems such as the control efficiency being poor and efficient prevention and treatment purpose, better than conventional method.

In another aspect the invention provides a composition comprising calcium carbonate for controlling the psyllid pest and preventing the greening disease by controlling the pest which infects the citrus plant with bacteria when sucking sap elaborate of the plant.

In another aspect the present invention provides a method to control the vector of green disease in citrus.

In another aspect the present invention provides a method to control or prevent pathogen transmission and disease spread in citrus plant.

In another aspect the method of present invention comprises applying said composition within 15 days after the pest birth on the citrus plant.

In another aspect the method of present invention reduces the rate of population of D. citri by applying said composition within 15 days after the pest birth on the citrus plant thus preventing emergence of the greening disease in the citrus crop. In an aspect the method of present invention provides the insect reduced rate up to 90% within three days and preventive effect up to 99%, thus prevention and treatment lasting effect is good.

### BRIEF DESCRIPTION OF THE DRAWINGS

FIG. 1. Experimental scheme about the preference test of Diaphorina citri treated with the composition according to present invention.

FIG. 2. Cumulative mean mortality (%) of adults of Diaphorina citri submitted to treatments with different concentrations of present invention. Values followed by the same letter do not differ significantly from one another by the Tukey (P<0.05). The error bar corresponds to the standard error (±EP). DAA=Days After Application.

FIG. 3. Cumulative average mortality (%) of adults of Diaphorina citri submitted treatments with different concentrations of present composition, being compared to each treatment throughout the daily evaluations. Values followed of the same letter did not differ significantly from each other by the Tukey's test (P<0.05). The error bar corresponds to the standard error (±EP). DAA=Days After Application.

FIG. 4. Food preference test of Diaphorina citri in C. sinensis with present composition at concentrations of 1% (Figure A), 2% (Figure B) and 4% (Figure C). Values followed by the same letter do not differ significantly by Tukey's test (P<0.05). DAA=Days After Application.

FIG. 5. Food preference test of Diaphorina citri in C. sinensis seedlings with the present composition at concentrations of 1% (Figure A), 2% (Figure B) and 4% (Figure C). Values followed by the same letter do not differ significantly by Tukey's test (P<0.05). DAA=Days After Application.

### DETAILED DESCRIPTION OF INVENTION

According to the present invention, there is provided a method of controlling citrus greening disease in citrus crop, said method comprising contacting the affected citrus crop with calcium carbonate upto about 15 days from the emergence of the D. citri in the citrus crop.

According to the present invention, the object of the invention was to provide an efficient method of controlling citrus green disease in citrus crop. The method comprises applying calcium carbonate to the citrus crop that was found to be surprisingly effective for controlling citrus green disease within one day of application in the citrus crop.

Surprisingly, it has been found that according to the method of present invention citrus trees are treated prophylactically with effective amounts of calcium carbonate, to control at least 30% the adult population of Diaphorina citri in the treated planting within at least one day after application.

In an aspect the present invention provides a method of controlling citrus greening disease in citrus crop, said method comprising contacting the affected citrus crop with a composition comprising calcium carbonate, upto about 15 days from the emergence of the target pest in the citrus crop.

In an aspect the present invention provides a method of controlling citrus greening disease in citrus crop, said method comprising contacting the affected citrus crop with a composition comprising calcium carbonate for upto about 15 days from the emergence of the greening disease in the citrus crop.

In an embodiment, calcium carbonate may be applied as a composition comprising about 10-70% of calcium carbonate.

In an embodiment the composition comprises micronized calcium carbonate.

In an embodiment the composition further comprises calcium oxide.

In an embodiment the composition is solid or liquid formulation.

In an embodiment the composition is a liquid formulation.

In an embodiment the present invention includes applying a liquid composition comprising about 50-70% of calcium carbonate.

In an embodiment the present invention provides a liquid composition comprising about 60% of calcium carbonate.

In an embodiment the present invention provides use of a liquid formulation comprising about 50-70% of calcium carbonate for controlling the citrus greening disease.

In an embodiment the composition of the present invention is applied to the citrus crop for at least four treatments to effectively control the citrus green disease.

In an embodiment at least six treatments of the citrus crop with calcium carbonate is carried out.

In an embodiment the method of present invention provides at least 30% control of Diaphorina citri in citrus crop.

In an embodiment the method of present invention provides at least 30% control of citrus greening disease in citrus crop within at least one day after application of said composition.

In an embodiment, at least about 30% control to about 70% control is achieved within at least two days after application.

In an embodiment, at least about 50% control to about 85% control is achieved within at least three days after application.

In an embodiment, at least about 65% control to about 95% control is achieved within at least four days after application.

In an embodiment, at least about 70% control to about 95% control is achieved within at least five days after application.

In an embodiment, the composition when used at a dosage of about 1% achieves at least 85% control within one day after application, and at least 90% control within three days after application.

In an embodiment, the composition when used at a dosage of about 2% achieves at least 85% control within one day after application, and at least 95% control within three days after application.

In an embodiment, the composition when used at a dosage of about 4% achieves at least 85% control within one day after application, and at least 95% control within three days after application.

In an aspect the present invention provides use of the composition comprising 50-70% of calcium carbonate to control the infestation of Diaphorina citri on citrus trees.

In an embodiment the method to control infestation of D. citri on citrus crop comprises treating the citrus crop by applying a composition comprising about 50-70% of calcium carbonate upto 15 days of pest birth.

In an embodiment the method to apply the composition is spraying the composition over the plant foliage.

In an embodiment, the formulation may be sprayed once every 3-5 days. In an embodiment, the formulation may be diluted with the sufficient amount of water before use.

In an embodiment the compositions of present invention may be mixed with additives such as organic or inorganic fertilizers, pesticides, insecticides, nematocides, fungicides, bactericides, a caricides, herbicides so as to provide an efficacious control of citrus greening.

In an embodiment, the method of the present invention comprises contacting the affected citrus crop with at least another chemotherapeutic agent.

Therefore, in this embodiment, the present invention provides a method of controlling citrus greening disease in citrus crop, said method comprising contacting the affected citrus crop with calcium carbonate and at least another chemotherapeutic agent, wherein calcium carbonate is contacted with the affected citrus crop upto about 15 days from the emergence of the greening disease in the citrus crop.

In an embodiment, the other chemotherapeutic agent is a bactericide.

Therefore, in this embodiment, the present invention provides a method of controlling citrus greening disease in citrus crop, said method comprising contacting the affected citrus crop with calcium carbonate and at one bactericide, wherein calcium carbonate is contacted with the affected citrus crop upto about 15 days from the emergence of the greening disease in the citrus crop.

In an embodiment, the bactericide is selected from the group consisting of amicarthiazol, bismerthiazol, bronopol, cellocidin, chloramphenicol, copper hydroxide, cresol, dichlorophen, dipyrithione, dodicin, ethylicin, fenaminosulf, fluopimomide, formaldehyde, hexachlorophene, hydrargaphen, 8-hydroxyquinoline sulfate, kasugamycin, ningnanmycin, nitrapyrin, octhilinone, oxolinic acid, tetracycline, penicillin carbenzazin, oxytetracycline, phenazine oxide, probenazole, saijunmao, saisentong, streptomycin, tecloftalam, thiodiazole-copper, thiomersal, xinjunan, and zinc thiazole.

In an embodiment, the bactericide is oxytetracycline.

In an embodiment, the other chemotherapeutic agent is an insecticide.

Therefore, in this embodiment, the present invention provides a method of controlling citrus greening disease in citrus crop, said method comprising contacting the affected citrus crop with calcium carbonate and at least one insecticide, wherein calcium carbonate is contacted with the affected citrus crop upto about 15 days from the emergence of D. citri in the citrus crop.

In an embodiment, the insecticide is selected from mineral oil, thiamethoxam, imidacloprid, bifenthrin, abamectin, abamectin+thiamethoxam, tolfenpyrad, acetamiprid, azadirachtin, clothianidin, flonicamid, flubendiamide, beta-cyfluthrin, sulfoxaflor, fenpropathrin, spinetoram, naled, dimethoate, cyantraniliprole, spinosad, spriodiclofen, pymetrozine, Chromobacterium subtugae, phosmet, chlorpyriphos, fenazaquin, diflubenzuron, spirotetramat, Burkholderia spp., fatty acid salts e.g. potassium salts, oxydemeton-methyl, zeta-cypermethrin, pyridaben, pyrifluquinazon, Isariafumosoroseus, fenpyroximate, Chenopodium ambrosioides extract, carbaryl, potassium silicate, flupyradifurone, chlorpyrifos, chlorpyrifos+zeta-cypermethrin, methidathion, aldicarb, dinotefuran, cyantraniliprole, Chlorantraniliprole, Chlorantraniliprole+thiamethoxam, dimethoate, monocrotophos, methomyl, carbofuran, malathion, oxamyl, and lambda-cyhalothrin.

In an embodiment, the insecticide is bifenthrine.

In an embodiment, the other chemotherapeutic agent is a micronutrient.

Therefore, in this embodiment, the present invention provides a method of controlling citrus greening disease in citrus crop, said method comprising contacting the affected citrus crop with calcium carbonate and at least one micronutrient, wherein calcium carbonate is contacted with the affected citrus crop upto about 15 days from the emergence of the D. citri in the citrus crop.

In an embodiment, the micronutrient is selected from the group consisting of zinc sulphate (ZnSO₄), copper sulphate (CuSO₄), boron (H₃BO₃), calcium sulphate (CaSO₄), ferric sulphate (FeSO₄), and potassium hydrophosphate (KH₂PO₄).

In an embodiment, the other chemotherapeutic agent is an antifeedant.

Therefore, in this embodiment, the present invention provides a method of controlling citrus greening disease in citrus crop, said method comprising contacting the affected citrus crop with calcium carbonate and at least one antifeedant, wherein calcium carbonate is contacted with the affected citrus crop upto about 15 days from the emergence of the D. citri in the citrus crop.

In an embodiment, the antifeedant is selected from the group consisting of chlordimeform, fentin, guazatine and pymetrozine.

In an embodiment, the other chemotherapeutic agent is an insect repellent.

Therefore, in this embodiment, the present invention provides a method of controlling citrus greening disease in citrus crop, said method comprising contacting the affected citrus crop with calcium carbonate and at least one insect repellant, wherein calcium carbonate is contacted with the affected citrus crop upto about 15 days from the emergence of the D. citri in the citrus crop.

In an embodiment, the insect repellent is selected from the group consisting of acrep, butopyronoxyl, camphor, d-camphor, carboxide, dibutyl phthalate, diethyltoluamide, dimethyl carbate, dimethyl phthalate, dibutyl succinate, ethohexadiol, hexamide, icaridin, methoquin-butyl, methylneodecanamide, 2-(octylthio)ethanol, oxamate, quwenzhi, quyingding, rebemide, and zengxiaoan.

In another embodiment, calcium carbonate or a compositions thereof may be applied to the affected plants before, after or simultaneously with one other chemotherapeutic agent.

In an embodiment, the chemotherapeutic agent may be fungicide, more preferably a contact fungicide.

Therefore, in this embodiment, the present invention provides a method of controlling citrus greening disease in citrus crop, said method comprising contacting the affected citrus crop with calcium carbonate and at least one contact fungicide, wherein calcium carbonate is contacted with the affected citrus crop upto about 15 days from the emergence of the D. citri in the citrus crop.

In an embodiment, the contact fungicide may be selected from copper fungicides, sulfur fungicides, dithiocarbamate fungicides, phthahmide fungicides, chloronitrile fungicides, sulfamide fungicides, guanidine fungicides, triazines fungicides and quinone fungicides.

The copper fungicides of the present invention are inorganic compounds containing copper, typically in the copper (II) oxidation state and are preferably selected from copper oxychloride, copper sulfate, copper hydroxide and tribasic copper sulfate (Bordeaux mixture).

The sulfur fungicides of the present invention are inorganic chemicals containing rings or chains of sulfur atoms and is preferably elemental sulfur.

The dithiocarbamate fungicides of the present invention contain a dithiocarbamate molecular moiety and are selected from amobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb and zineb.

The phthahmide fungicides of the present invention contain a phthahmide molecular moiety and are selected from folpet, captan and captafol.

The chloronitrile fungicide of the present invention comprises an aromatic ring substituted with chloro- and cyano-substituents and is preferably chlorothalonil.

The sulfamide fungicides of the present invention are preferably selected from dichlofluanid and tolylfluanid.

The guanidine fungicides of the present invention are preferably selected from dodine, guazantine and iminoctaadine.

The triazine fungicide of the present invention is preferably anilazine.

The quinone fungicide of the present invention is preferably dithianon.

In an embodiment, the multi-site contact fungicide of the present invention is a dithiocarbamate fungicide selected from amobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb and zineb.

In an embodiment, the dithiocarbamate fungicide is mancozeb.

In an embodiment, the multi-site contact fungicide is a combination of mancozeb and chlorothalonil.

In an embodiment the present invention provides a method of using compositions comprising calcium carbonate, for the treatment of citrus trees for at least 1 day to control at least 30% of psyllids and D. citri, vectors bacteria of the genus Candidatus Liberibacter causing citrus green disease. The population reduction rate of D. citri according to the present method is further increased to at least 90% for extended period, preferably within 15 days after the application.

In an embodiment, a composition comprising calcium carbonate may be used.

In an embodiment, a liquid composition comprising micronized calcium carbonate may be used.

In an embodiment, the preferred composition is a liquid formulation comprising 58-62% micronized calcium carbonate and 40-42% soy lecithin.

In an embodiment, the preferred composition is a liquid formulation comprising 58-62% micronized calcium carbonate and calcium oxide filler.

In an embodiment, the preferred composition is the calcium carbonate composition available Decco®.

In an embodiment, the population reduction rate of D. citri is at least about 30% control to about 70% control within at least two days after application.

In an embodiment, the population reduction rate of D. citri is at least about 50% control to about 85% control within at least three days after application.

In an embodiment, the population reduction rate of D. citri is at least about 65% control to about 95% control within at least four days after application.

In an embodiment, the population reduction rate of D. citri is at least about 70% control to about 95% control within at least five days after application.

According to the present method the composition when used at a dosage of about 0.1 to 10% achieves high control of D. citri within 15 days after application.

According to the invention the advantages of present method is surprisingly high mortality rates of D. citri adults, when applied to citrus crop leading to quick control of D. citri adult population.

The invention will now be described in more details with reference to the following examples. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and following examples, but by all embodiments and methods within the scope and spirit of the invention.

### Examples

### Material and Methods

### Insects-Pests

The experiment was conducted with adults of D. citri and percentage control up to 15 days was observed. The adults were obtained from a mass enterprise creation, conducted in Murrayapaniculata (L.) plants under controlled conditions of temperature (T=25±3° C.); relative humidity (RH=65±10%) and luminosity (photoperiod 14:10 h).

Seedlings of Citrus sinensis

As experimental unit and food substrate for D. citri were used seedlings of Citrus sinensis (L.) Osbeck (Rutaceae) in stage V3, free from pathogens and pests, as well as residues of any type of pesticide.

Evaluation of Residual Effect on Adults of Diaphorina citri

The treatments consisted of a control (no application) (T1), in addition to application-related treatments of the present composition at the dosages of 1% (T2), 2% (T3) and 4% (T4).

Six seedlings of C. sinensis (six replicates) were used for each treatment. In each repetition two shoots of approximately 15 cm were selected, one of them covered by a brown kraft paper bag, and surface application of composition available from Decco®) was analyzed. The treatments were sprayed at dawn, on the foliage of the crop, with a 20 Liters sprayer, with type tip, and the application was provided so as to cover total leaf on spraying.

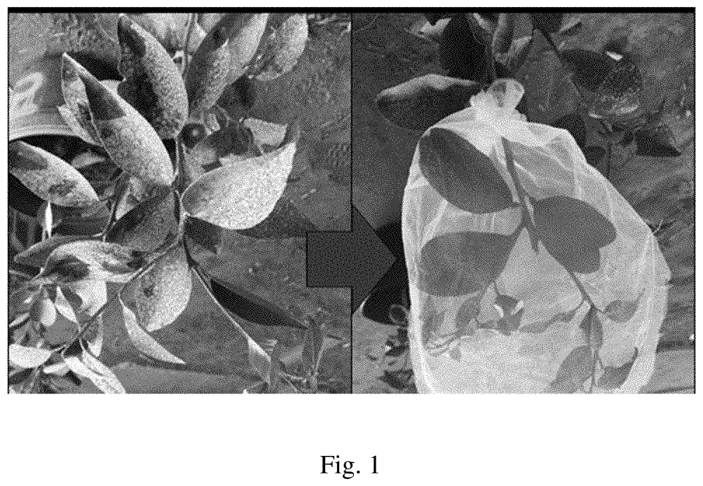

After drying the composition on the foliage, with the shoots being wrapped by a single cage made of type fabric vole (30 cm long×20 cm wide×40 cm high), attached to the crown of the plant, containing 10 non-sexed adults of D. citri (FIG. 1).

Mortality assessments and also the insect preference test (shoot treated with the present composition; shoot not treated with the present composition; were evaluated daily for five days, between 11 and 12 h, considered a period of high activity on the part of the insect. The experiment was conducted in a completely randomized design, consisting of four treatments and six treatments data were subjected to analysis of variance and the means were compared by the Tukey test (P<0.05) through the statistical software Sisvar 5.6.

### Results:

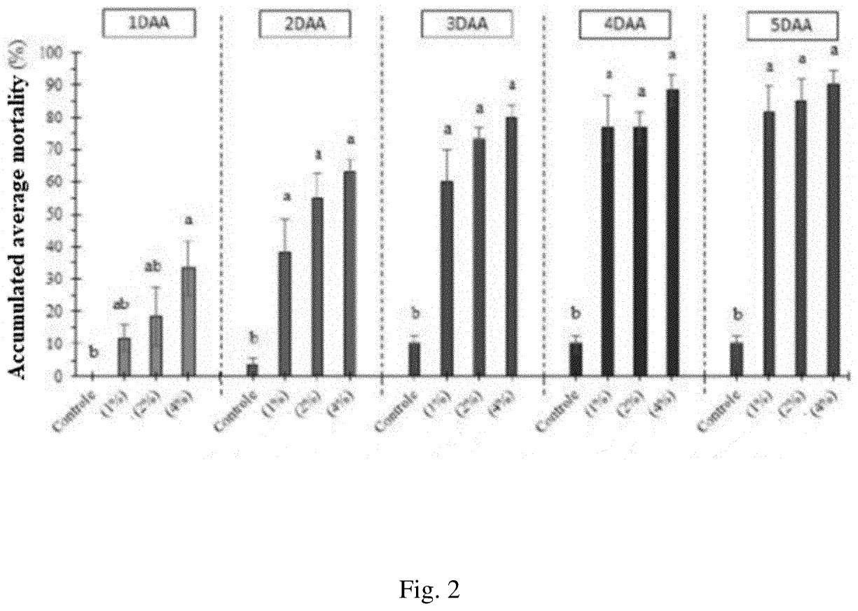

Adult mortality of D. citri was observed in all treatments related to the application of the present composition (FIG. 2).

It was observed that on the first day (1DAA), the present composition, in the concentration of 4%, caused a mortality of 33.33±8.43%, differing statistically in relation to the control (F=4.553, gl=3.20, P<0.05) (FIG. 2).

Also, on the second day after application (2DAA), both concentrations results, but statistically different from control (F=15.394, gl=3.20, P<0.05), with variation in adult citrus psyllid between 38.33±10.46% and 65.33±3.33% (FIG. 2). The same scenario was observed in 3DAA (F=30.593; gl=3, 20; P<0.05), with mortality between 60±10% and 80±3.65%; 4DAA (F=32.205, gl=3.20, P<0.05), with reduction in density population of D. citri between 76.67±10.22% and 88.33±4.77%; and 5DAA (F=42.810; gl=3.20, P<0.05), with mortality ranging from 81.67±7.92% to 90±4.47% (FIG. 2).

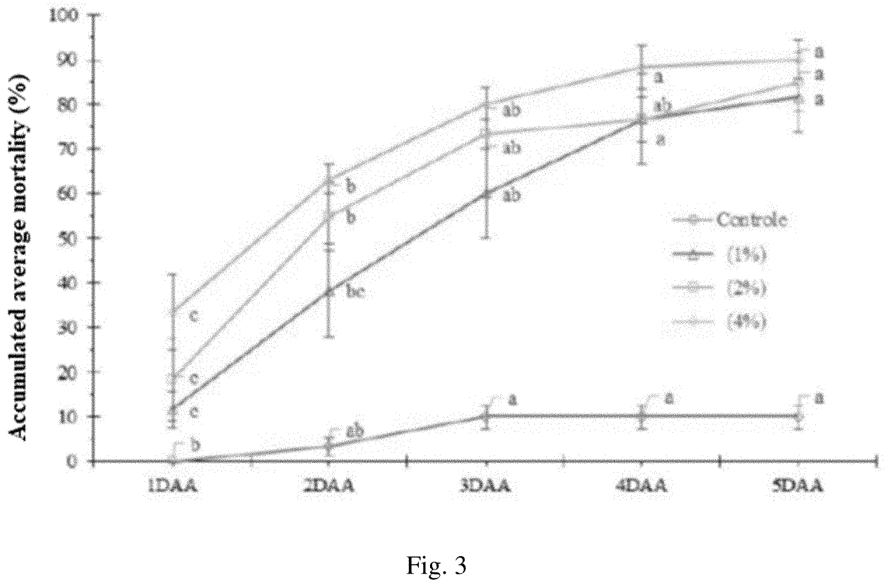

Accordingly, the present composition (1%) caused accumulated average mortality of adults of D. citri between 11.67±4.01% and 81.67±7.92% during the five days of after treatment, with a significant difference between 4DAA and 5DAA compared to 1DAA and 2DAA (F=10.668, gl=4.25, P<0.05) (FIG. 3).

The accumulated average mortality of adult psyllids from the application of present composition (2%) was between 18.33±9.10% and 85±6.71%, presenting significant results between 5DAA and 2DAA (F=15,946, gl=4, 25; P<0.05) (FIG. 3). In relation to the present composition (4%), the adult mortality rates of D. citri ranged from 33.33±8.43% and 90±4.47% between 1 and 5 DAA, with significant difference between 4DAA and 5DAA in relation to 1DAA and 2DAA (F=18.383, gl=4.25, P<0.05) (FIG. 3).

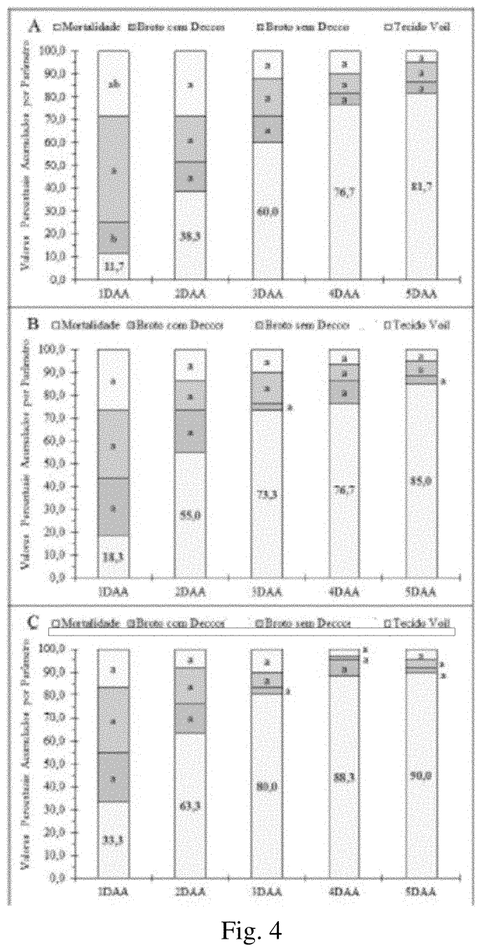

Regarding the food preference of D. citri in relation to seedlings of C. sinensis sprayed at the different concentrations of present composition, it was observed that only the first day after application (1DAA) there was a significant difference in treatments, with a higher number of insects in presence of the commercial product when compared to shoots sprayed with present composition (1%) (F=9.837, gl=2.15, P<0.05) (FIG. 4A).

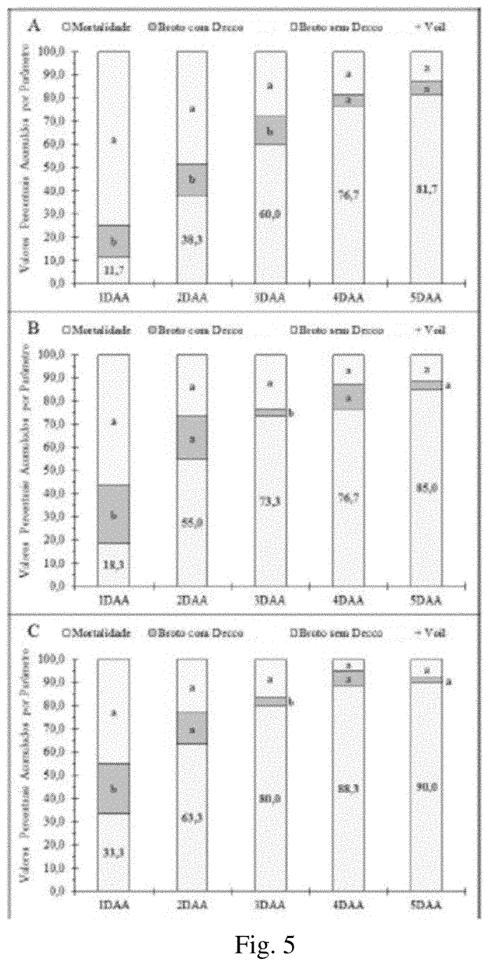

From the comparison between the presence of citrus psyllids in sprouts with present composition in relation to the bud without present invention, it was observed that there was a significant difference in the preference of the surviving insects for the shoot without present composition after 1, 2 and 3 days of present composition application, using present composition at 1% concentration (FIG. 5A). In the first evaluation (1DAA), 75% of the insects were present on shoots without this present composition, while only 13.33% were in the shoots sprayed with present composition (1%), presenting a significant difference between these treatments (F=54.76, gl=1, 10, P<0.05) (FIG. 5A). At 2DAA, the largest share of the surviving adults of D. citri were in the bud without the present composition or in the represented 48.33%, while 13.33% presented with present composition (1%), results that differed statistically from each other (F=13.047, gl=1, 10, P<0.05) (FIG. 5A). On the third day after application (3DAA), the percentage of individuals in shoots without the commercial product was of 28.33%, differing significantly from the percentage of psyllids in shoots sprayed (11.67%) (F=5.097; gl=1.0, P<0.05) (FIG. 5A).

In relation to the present composition in the 2% concentration, observed a significant difference between treatments in the first and third evaluations (1DAA and 3DAA) (FIG. 5B). On the first day after assessment (1DAA), a total of 56.67% of the surviving insects were on the shoot without the present composition or versus 25% of the psyllids were concentrated on the shoot with present invention (2%), with significant difference between treatments (F=13,175, gl=1, 10; P<0.05) (FIG. 5B). At 3DAA, only 3.33% of the insects were on the sprayed foliage, with 23.33% of surviving adults without the present composition (F=25.714; gl=1, 10; P<0.05) (FIG. 5B).

In the more concentrated dosage of present composition represented by concentration of 4%, it was observed a significant difference between the treatments in the first and third evaluations (1DAA and 3DAA) (FIG. 5C). The biggest of the surviving psyllids presented in the 1DAA on the shoot without the present composition, represented by 45%, while 21.67% were present on the foliage sprayed with present composition (4%), differing (F=5.385, gl=1, 10, P<0.05) (FIG. 5C). On the third day after application (3 DAA) only 3.33% of the insects were on the foliage 16.67% of surviving adults were on the shoot without present composition (F=20.00, gl=1, 10, P<0.05) (FIG. 5C).

Therefore, it was concluded that the present composition in the three concentrations, causes unexpectedly high mortality rates of D. citri adults under confinement, thus presents repellent effect in adults of D. citri

1. A method of controlling citrus greening disease in an affected citrus crop, said method comprising contacting the affected citrus crop with calcium carbonate from emergence of Diaphorina citri up to about 15 days from the emergence of the Diaphorina citri in the affected citrus crop.

2. The method as claimed in claim 1, wherein the calcium carbonate is contacted with an adult population of Diaphorina citri in the affected citrus crop.

3. The method as claimed in claim 1, wherein the calcium carbonate is in the form of a liquid composition comprising micronized calcium carbonate.

4. The method as claimed in claim 3, wherein the composition comprises about 60 weight % calcium carbonate by total weight of the composition.

5. The method as claimed in claim 3, wherein the composition is applied at a dosage of at least 1 weight % calcium carbonate.

6. The method as claimed in claimed 1, wherein at least four treatments of the affected citrus crop with the calcium carbonate are carried out.

7. The method as claimed in claim 1, wherein at least six treatments of the affected citrus crop with the calcium carbonate are carried out.

8. The method as claimed in claim 1, wherein at least 30% control of Diaphorina citri is achieved within at least one day after application.

9. The method as claimed in claim 1, wherein at least about 30% control of Diaphorina citri to about 70% control Diaphorina citri is achieved within at least two days after application.

10. The method as claimed in claim 1, wherein at least about 50% control Diaphorina citri to about 85% control is achieved within at least three days after application.

11. The method as claimed in claim 1, wherein at least about 65% control to about 95% control Diaphorina citri is achieved within at least four days after application.

12. The method as claimed in claim 1, wherein at least about 70% control Diaphorina citri to about 95% control Diaphorina citri is achieved within at least five days after application.

13. The method as claimed in claim 1, wherein the composition when used at a dosage of about 1% achieves at least 85% control of Diaphorina citri within one day after application, and at least 90% control of Diaphorina citri within three days after application.

14. The method as claimed in claim 1, wherein the composition when used at a dosage of about 2% achieves at least 85% control of Diaphorina citri within one day after application, and at least 95% control of Diaphorina citri within three days after application.

15. The method as claimed in claim 1, wherein the composition when used at a dosage of about 4% achieves at least 85% control of Diaphorina citri within one day after application, and at least 95% control of Diaphorina citri within three days after application.

16. The method as claimed in claim 1, further comprising additionally treating the affected citrus crop with at least another chemotherapeutic agent selected from a bactericide, an insecticide, a micronutrient, an antifeedant, an insect repellent or a contact fungicide.

17. The method as claimed in claim 16, wherein:
(i) the bactericide is selected from the group consisting of amicarthiazole, bismerthiazole, bronopol, cellocidin, chloramphenicol, copper hydroxide, cresol, dichlorophen, dipyrithione, dodicin, ethylicin, fenaminosulf, fluopinomide, formaldehyde, hexachlorophene, hydrargaphen, 8-hydroxyquinoline sulfate, kasugamycin, ningnanmycin, nitrapyrin, octhilinone, oxolinic acid, tetracycline, penicillin carbenzazin, oxytetracycline, phenazine oxide, probenazole, saijunmao, saisentong, streptomycin, tecloftalam, thiodiazole-copper, thiomersal, xinjunan, and zinc thiazole;
(ii) the insecticide is selected from the group consisting of mineral oil, thiamethoxam, imidacloprid, bifenthrine, abamectin, abamectin+thiamethoxam, tolfenpyrad, acetamiprid, azadirachtin, clothianidin, flonicamid, flubendiamide, beta-cyfluthrin, sulfoxaflor, fenpropathrin, spinetoram, naled, dimethoate, cyantraniliprole, Spinosad, spriodiclofen, pymetrozine, Chromobacterium subtugae, phosmet, chlorpyriphos, fenazaquin, diflubenzuron, spirotetramat, Burkholderia spp., fatty acid salts, e.g. potassium salts, Isariafumosoroseus, fenpyroximate, Chenopodium ambrosioides extract, carbaryl, potassium silicate, flupyradifurone, chlorpyrifos, cyantraniliprole, Chlorantraniliprole, Chlorantraniliprole+thiamethoxam, dimethoate, monocrotophos, methomyl, carbofuran, malathion, oxamyl, and lambda-cyhalothrin;
(iii) the micronutrient is selected from the group consisting of zinc sulphate (ZnSO₄), copper sulphate (CuSO₄), boron (H₃BO₃), calcium sulphate (CaSO₄), ferric sulphate (FeSO₄), and potassium hydrophosphate (KH₂PO₄);
(iv) the antifeedant is selected from the group consisting of chlordimeform, fentin, guazatine, and pymetrozine;
(v) the insect repellent is selected from the group consisting of acrep, butopyronoxyl, camphor, d-camphor, carbazide, dibutyl phthalate, diethyltoluamide, dimethyl carbate, dimethyl phthalate, dibutyl succinate, ethohexadiol, hexamide, icaridin, methoquin-butyl, methylneodecanamide, 2-(octylthio)ethanol, oxamate, quwenzhi, quyingding, rebemide, and zengxiaoan; and
(vi) the contact fungicide may be selected from the group consisting of copper fungicides, sulfur fungicides, dithiocarbamate fungicides, phthalamide fungicides, chloronitrile fungicides, sulfamide fungicides, guanidine fungicides, triazines fungicides and quinone fungicides.
